(19) United States
(12) Patent Application Publication
(10) Pub. No.: US 2002/0055382 A1
(43) Pub. Date: May 9, 2002

(54) Gaming machine

(76) Inventor: Jason Meyer, Wollstonecraft (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/971,139

(22) Filed: Oct. 4, 2001

(30) Foreign Application Priority Data
Oct. 4, 2000 (AU) PR1664

(51) Int. Cl. A63F 13/00

(52) U.S. Cl. 463/20; 463/25

(57) ABSTRACT

A gaming machine of the type that displays an array 20 of randomly arranged symbols having predetermined pay lines 30 on which the player can bet on the occurrence of a winning combination. In response to a trigger event one or more bonus pay lines 50 activate whereby winnings are paid for any winning combinations on the bonus pay lines despite these pay lines not carrying a bet. If all the available pay lines 30 in the base game are carrying a bet, the bonus pay lines 50 may be accommodated in an extended portion 40 of the array 20.

### FIELD OF THE INVENTION

The present invention relates to gaming machines. The invention has been developed primarily for computerised gaming machines and will be described herein with reference to that application. However the invention is not limited to that particular field of use and may be suitable for many other applications such as gaming facilitated by the Internet.

### BACKGROUND OF THE INVENTION

Gaming machines have long been known and are now one of the most common forms of gambling. Usually gaming machines will simulate a well known game of chance. One of the oldest and best known forms of gaming machine is the rotating reel type “poker machine”.

Traditional poker machines use a series of three, four or five reels, each reel having symbols on its peripheral edge. The reels are rotated upon the placement of a bet and then stopped to produce an arrangement of randomly selected symbols. Winnings are paid if the random arrangement of symbols matches one of the predetermined winning combinations.

Gaming machines can “pay winnings” in a variety of ways. These include dispensing money, dispensing tokens that can be redeemed for money, and adding credits to a credit metre that can be used for placing bets or redeemed for money. The winnings may even entail awarding the player one or more “free games” whereby the machine operates without the player needing to place a bet. Therefore, throughout the specification, the use of terminology such as “winnings are paid”, “pay winnings” and so on, will be a reference to awarding the player some type of benefit or desirable outcome.

More recently, these gaming machines have been computerised with a video screen replacing the physically rotating reels. Typically, the display screen presents an array of symbols in five columns and three rows equating to the symbols that would normally be seen on the five physically rotating reels of the old style mechanical machines.

Computerised machines have allowed players to bet on the symbols appearing in one or more rows, or other lines of symbols that extend through the array. In the old style mechanical machines, the middle row was the only row available for betting on. Today it is commonplace for these machines to offer the opportunity to simultaneously bet on the combinations in all three rows and various angle or ‘zig zag’ lines. As the practical options for “pay lines” of symbols have been exhausted, game developers have looked to subsidiary games (for example, a simulated horse race or the like) in an effort to further increase gaming enjoyment for players. These subsidiary games are commonly referred to as “features” and they usually initiate in response to a trigger event designed to occur frequently enough to maintain player interest. However the nature of the feature game is usually very different from the primary or base game and may not particularly appeal to some players.

In light of this, it has been proposed to configure the gaming machine so that it randomly chooses a line of symbols through the array and designates this line to be an additional pay line. Any winning combinations of symbols along this line will pay winnings despite not carrying a bet. Unfortunately, with the level of screen activity associated with the standard pay lines that are carrying a bet, there are difficulties in highlighting additional random pay line so that the player recognises that a “mystery” pay line has been provided and feels a sense of bonus. Furthermore, some players can feel a sense of skepticism, albeit completely unfounded, at the computers choice of symbols that constitute the mystery pay line.

### SUMMARY OF THE INVENTION

In accordance with the present invention, there is invention to overcome or ameliorate at least one of the disadvantages of the prior art, or to provide a useful alternative.

Further, in accordance with the present invention, there is provided a gaming machine comprising:

means adapted to display an array of randomly arranged symbols;

means adapted to accept a bet on the occurrence of winning combinations of symbols in at least one predetermined portion of the array;

means adapted to pay winnings on the occurrence of any of the winning combinations in any of the at least one predetermined portion of the array carrying a bet; and,

in response to a trigger event, means adapted to pay winnings on the occurrence of a winning combination in at least one of the predetermined portion of the array that does not carry a bet.

Still further, in accordance with the present invention, there is provided a method of operation for a gaming machine having a display for presenting an array of symbols randomly selected from a set of symbols, the method comprising the steps of:

accepting a bet on the occurrence of winning combinations of symbols in at least one predetermined portion of the array;

paying winnings on the occurrence of any of the winning combinations in any of the at least one predetermined portion of the array carrying a bet; and,

in response to a trigger event, paying winnings on the occurrence of a winning combination in at least one of the predetermined portion of the array that does not carry a bet.

By making the bonus pay line one of the standard pay lines the player is familiar with its position within the array and more readily recognises when it becomes a bonus pay line. Furthermore, as it is one of the standard pay lines, there is less tendency for the skepticism that can arise when gaming machines randomly select a mystery pay line.

In some embodiments, the array is extended upon the trigger event and the at least one predetermined portion that the machine will pay winnings on, despite not carrying a bet, comprises at least part of the extended portion of the array.

This preferred aspect of the present invention takes account of the situation where the player is already betting on all available pay lines. The extended array and bonus pay line suitably appear as soon as the reels stop spinning and the trigger event occurs, or, the extended array and bonus payline suitably appear and become active in the spin of the reels subsequent to the spin that produces the trigger event.

In a further preferred form, the array is generally rectangular in shape and the portions available to carry a bet are pay lines consisting of one symbol from each of the columns in the array wherein adjacent symbols in a pay line are positioned either laterally or diagonally adjacent each other in the array; and, the at least one predetermined portion that the machine will pay winnings on, despite not carrying a bet, is comprised of bonus pay lines consisting of one symbol from each of the columns in the array wherein adjacent symbols in a pay line are positioned either laterally or diagonally adjacent each other in the array.

Conveniently, the trigger event is a set number of identical symbols scattered through the array. The trigger is suitably also one or more specified trigger combinations of symbols occurring in any of the pay lines or any of the bonus pay lines. In this way the player can continue to extend the array to increase the chances of winning.

A gaming machine according to the present invention provides a feature that has a similar nature to the base game but still gives the player a sense of bonus. The bonus pay lines increase the chances of winning without any extra risk or cost. Furthermore, if the bonus pay lines are added to the existing array, the screen activity is increased and is therefore more visually stimulating.

Gaming machines according to the present invention also conveniently permit a feature that can involve a number of bonus pay lines. Furthermore, as the pay lines are the standard pay lines of known configuration rather than a randomly configured mystery pay line, the player knows what to expect and is more comfortable that the feature is a genuine bonus.

These and other aspects will be apparent to one skilled in the art upon reading and understanding the specification.

### BRIEF DESCRIPTION OF THE DRAWINGS

Preferred embodiments of the invention will now be described by way of example only with reference to the accompanying drawings in which:

FIG. 1 shows a schematic representation of the display screen of a gaming machine according to the present invention; and

FIG. 2 shows a schematic representation of the display screen of FIG. 1 after the occurrence of a trigger event.

### DETAILED DESCRIPTION OF THE PREFERRED EMBODIMENTS

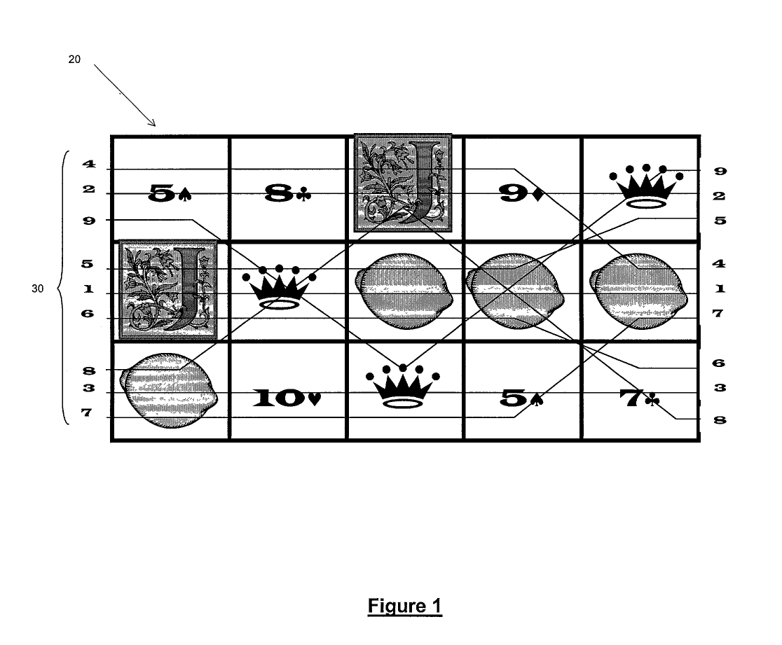

Referring to FIG. 1, the screen shows an array 20 of symbols in five columns and three rows. The columns and rows equate to the symbols that would normally be seen on a five reel mechanical ‘poker machine’.

Nine separate pay lines 30 are provided for the player who can place bets on any number of them. The player bets on the occurrence of predetermined winning combinations of symbols appearing on the chosen pay lines 30. The winning combinations and the amount won for each is shown on a tabulated “score card” (not shown) displayed on the screen or the facia of the gaming machine.

Having placed a bet on at least one of the pay lines 30, the screen displays a simulation of the five reels spinning. When the reels are brought to rest, the microprocessor controlling the gaming machine checks the random arrangement of symbols for any winning combinations on any of the pay lines 30 carrying a bet.

In the event of a trigger, such as a ‘scatter’ of any four identical symbols anywhere in the array 20, one or more bonus pay lines will become active regardless of whether they are carrying a bet. Once activated, a winning combination appearing in any of the bonus pay lines will pay winnings despite not carrying a bet.

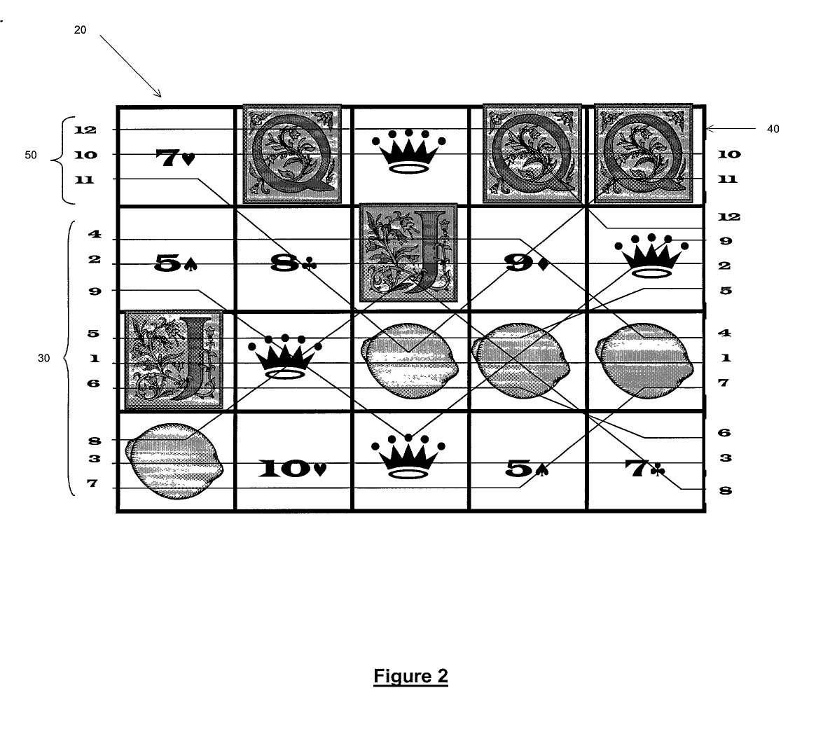

The bonus pay lines may be any of the originally available pay lines 2-2 through to 9-9 that were not carrying a bet. However, all nine pay lines carrying a bet or a trigger may cause extra pay lines to appear in the array 20 which were not originally available. As shown in FIG. 2, the trigger has added another row 40 to provide three extra pay lines 50. Any or all of these extra pay lines 50 may become the bonus pay lines awarded to the player.

However, if only pay line 10-10 is awarded as a bonus pay line, pay lines 11-11 and 12-12 should still be made available to the player for betting. The greater number of pay lines carrying a bet for each spin will tend to increase the return or profit made from the machine.

The array 20 may be further extended in response to subsequent triggers by the addition of more rows and/or columns. If the array 20 is extended in order to provide bonus pay lines it would be more convenient to configure the game so that the bonus pay lines 50 only become active on the “spin” subsequent to the spin that produced the trigger event. This is because the appearance of the additional row of symbols 40 and the extra pay lines 50, and the subsequent immediate checking for winning combinations and paying any winnings, is a significant departure from the long standing tradition of forming the random array of symbols through a simulated reel spin. This may prove to be an uncomfortable departure from conventional gaming machines for many players. Accordingly, in the interests of consistency, the random arrangement of symbols should always be produced by a simulated reel spin and any bonus pay lines in an extend portion of the array should only be activated in the spin subsequent to the spin that produced the trigger event.

The number of spins in which the bonus pay lines remain active will be a decision for the game designer. The longer the bonus pay lines remain active the less generous the winnings on other winning combinations can be and/or less frequently the winning combinations will occur. If the array 20 has been extended in order to provide bonus pay lines, the game designer may wish to keep the array in it's extended configuration to encourage the player to place bets on the additional pay lines 50.

The present invention provides a game feature with bonus pay lines to significantly improve the chances of a winning outcome. Once the trigger event occurs, the player knows what pay lines will become active and this provides more certainty than a machine that randomly selects a symbol from each column in the array to form a mystery bonus pay line. Knowing what pay lines will activate helps to avert any feelings of skepticism that may arise from a randomly chosen mystery pay line. Furthermore, with extra pay lines and/or extra symbols on the display screen, the screen activity escalates as the game progresses to maintain the players interest.

The present invention has been described herein by way of example only. Skilled workers in this field will readily recognise many variations and modifications which do not depart from the spirit and scope of the broad inventive concept. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A gaming machine comprising:
means adapted to display an array of randomly arranged symbols;
means adapted accept a bet on the occurrence of winning combinations of symbols in at least one predetermined portion of the array;
means adapted to pay winnings on the occurrence of any of the winning combinations in any of the at least one predetermined portion of the array carrying a bet; and,
in response to a trigger event, means adapted to pay winnings on the occurrence of a winning combination in at least one of the predetermined portion of the array that does not carry a bet.

2. A gaming machine according to claim 1 wherein the array is extended upon the trigger event and the at least one portion that the machine will pay winnings on, despite not carrying a bet, comprise at least part of the extended portion of the array.

3. A gaming machine according to claim 2 wherein the array is generally rectangular in shape and the portions available to carry a bet are pay lines consisting of one symbol from each of the columns in the array wherein adjacent symbols in a pay line are positioned at a selected one of those laterally and diagonally adjacent to each other in the array; and
the at least one predetermined portion that the machine will pay winnings on, despite not carrying a bet, is comprised of bonus pay lines consisting of one symbol from each of the columns in the array wherein adjacent symbols in a pay line are positioned at a selected one of those laterally and diagonally adjacent each other in the array.

4. A gaming machine according to claim 3 wherein the trigger event is a set number of identical symbols scattered through the array.

5. A gaming machine according to claim 3 wherein the trigger event is at least one specified trigger combination of symbols occurring in any of the pay lines.

6. A gaming machine according to claim 4 wherein the trigger event is at least one specified trigger combination of symbols in any of the bonus pay lines.

7. A method of operation for a gaming machine having a display for presenting an array of symbols randomly selected from a set of symbols, the method comprising the steps of:
accepting a bet on the occurrence of winning combinations of symbols in at least one predetermined portion of the array;
paying winnings on the occurrence of any of the winning combinations in any of the at least one predetermined portion of the array carrying a bet; and,
in response to a trigger event, paying winnings on the occurrence of a winning combination in at least one of the predetermined portion of the array that does not carry a bet.

8. A method according to claim 7 wherein the array is extended upon the trigger event and the at least one portion that the machine will pay winnings on, despite not carrying a bet, comprise at least part of the extended portion of the array.

9. A method according to claim 8 wherein the array is generally rectangular in shape and the portions available to carry a bet are pay lines consisting of one symbol from each of the columns in the array wherein adjacent symbols in a pay line are positioned at a selected one of those laterally and diagonally adjacent to each other in the array; and
the at least one predetermined portion that the machine will pay winnings on, despite not carrying a bet, is comprised of bonus pay lines consisting of one symbol from each of the columns in the array wherein adjacent symbols in a pay line are positioned at a selected one of those laterally and diagonally adjacent each other in the array.

10. A method according to claim 9 wherein the trigger event is a set number of identical symbols scattered through the array.

11. A method according to claim 9 wherein the trigger event is at least one specified trigger combination of symbols occurring in any of the pay lines.

12. A method according to claim 10 wherein the trigger event is at least one specified trigger combination of symbols in any of the bonus pay lines.
